(19) United States
(12) Patent Application Publication
(10) Pub. No.: US 2024/0012872 A1
(43) Pub. Date: Jan. 11, 2024

(54) TOTAL INTERACTION METHOD AND DEVICE FOR FEATURE INTERACTION MODELING IN RECOMMENDATION SYSTEMS

(71) Applicant: NEUCHIPS CORPORATION, Hsinchu City (TW)

(72) Inventors: Ching-Yun Kao, Taipei City (TW); Wei-Hsiang Kuo, Tainan City (TW); Juinn-Dar Huang, Hsinchu County (TW)

(73) Assignee: NEUCHIPS CORPORATION, Hsinchu City (TW)

(21) Appl. No.: 17/894,155

(22) Filed: Aug. 23, 2022

(30) Foreign Application Priority Data
Jul. 7, 2022 (TW) 111125512

(51) Int. Cl. G06F 17/16; G06K 9/62

(52) U.S. Cl. CPC G06F 17/16; G06K 9/6201

(57) ABSTRACT

A total interaction method and device to compute an interaction relationship between multiple features in a recommendation system is provided. The total interaction method includes: adding a plurality of categorical feature vectors to a first matrix, wherein each of the categorical feature vectors includes a plurality of latent features; performing one of categorical feature interaction computation and latent feature interaction computation on the first matrix to generate a second matrix; transposing the second matrix to generate a transposed matrix; and performing the other one of the categorical feature interaction computation and the latent feature interaction computation on the transposed matrix to generate a total interaction result.

### CROSS-REFERENCE TO RELATED APPLICATION

This application claims the priority benefit of Taiwan application serial no. 111125512, filed on Jul. 7, 2022. The entirety of the above-mentioned patent application is hereby incorporated by reference herein and made a part of this specification.

### BACKGROUND

### Technical Field

The invention relates to a recommendation system, and particularly relates to a total interaction method and device for feature interaction modeling in recommendation systems.

### Description of Related Art

In a click-through rate prediction task of a recommendation system, how to accurately capture the complex interaction relationship between features is very important, which is one of factors that affects the accuracy of a prediction model. The recommendation system based on deep learning may use an embedding learning technology to learn latent features in sparse and high-dimensional raw categorical data, and map them into dense vectors represented in a new feature space. In general, this vector is referred to as a categorical feature, and elements therein (the learned latent features) are referred to as latent features.

How to use all the categorical feature vectors to perform feature interaction to obtain a feature interaction result is one of many technical issues in this field. The feature interaction result may be fed into a prediction model to obtain a prediction result of the recommendation system. Therefore, how to accurately perform feature interaction is a key to improve model accuracy. Current techniques compute a second order interaction relationship in a simple manner, such as computing an inner product of any two categorical features. On the other hand, current techniques ignore an interaction relationship between the latent features learned during the embedding process.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a total interaction method and device for computing an interaction relationship between a plurality of features in a recommendation system to generate a total interaction result.

In an embodiment of the invention, the total interaction method includes: adding a plurality of categorical feature vectors to a first matrix, where each of the categorical feature vectors includes a plurality of latent features; performing one of categorical feature interaction computation and latent feature interaction computation on the first matrix to generate a second matrix; transposing the second matrix to generate a transposed matrix; and performing the other one of the categorical feature interaction computation and the latent feature interaction computation on the transposed matrix to generate a total interaction result.

In an embodiment of the invention, the total interaction device includes a first memory, a first interaction computation circuit, a second memory and a second interaction computation circuit. The first memory is configured to store a plurality of categorical feature vectors, where the categorical feature vectors are added to a first matrix, and each of the categorical feature vectors includes a plurality of latent features. The first interaction computation circuit is coupled to the first memory and configured to perform one of categorical feature interaction computation and latent feature interaction computation on the first matrix to generate a second matrix. The second memory is coupled to the first interaction computation circuit to receive the second matrix and configured to transpose the second matrix to generate a transposed matrix. The second interaction computation circuit is coupled to the second memory to receive the transposed matrix. The second interaction computation circuit performs the other one of the categorical feature interaction computation and the latent feature interaction computation on the transposed matrix to generate a total interaction result.

In an embodiment of the invention, the total interaction device includes a memory and a processor. The memory is configured to provide a first matrix, where a plurality of categorical feature vectors are added to the first matrix, and each of the categorical feature vectors includes a plurality of latent features. The processor is coupled to the memory. The processor performs one of categorical feature interaction computation and latent feature interaction computation on the first matrix to generate a second matrix. The processor transposes the second matrix to generate a transposed matrix. The processor performs the other one of the categorical feature interaction computation and latent feature interaction computation on the transposed matrix to generate a total interaction result.

Based on the above description, the plurality of categorical feature vectors in the embodiments of the invention are added to the first matrix. The first matrix is subjected to a first feature interaction computation to produce the second matrix. The second matrix is transposed to produce the transposed matrix. The transposed matrix is subjected to a second feature interaction computation to produce the total interaction result. Therefore, the total interaction result includes both of a categorical feature interaction relationship and a latent feature interaction relationship.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a neural network framework of a deep learning recommendation model (DLRM) according to an embodiment of the present invention.

FIG. 2 is a schematic flowchart of a total interaction method according to an embodiment of the invention.

FIG. 3 is a schematic circuit block diagram of a total interaction device according to an embodiment of the invention.

FIG. 4 is a schematic circuit block diagram of a total interaction device according to another embodiment of the invention.

FIG. 5 is a schematic diagram of a process of performing total interaction computation on a first matrix according to an embodiment of the invention.

FIG. 6 is a schematic diagram of a process of performing total interaction computation on the first matrix according to another embodiment of the invention.

### DESCRIPTION OF THE EMBODIMENTS

A term “couple” used in the full text of the disclosure (including the claims) refers to any direct and indirect connections. For example, if a first device is described to be coupled (connected) to a second device, it is interpreted as that the first device is directly coupled to the second device, or the first device may be indirectly coupled to the second device through other devices or connection means. Furthermore, “first”, “second”, etc., mentioned in the specification (including the claims) are merely used to name discrete components and should not be regarded as limiting the upper or lower bound of the number of the components, nor is it used to define a manufacturing order or setting order of the components. Moreover, wherever possible, components/members/steps using the same referential numbers in the drawings and description refer to the same or like parts. Components/members/steps using the same referential numbers or using the same terms in different embodiments may cross-refer related descriptions.

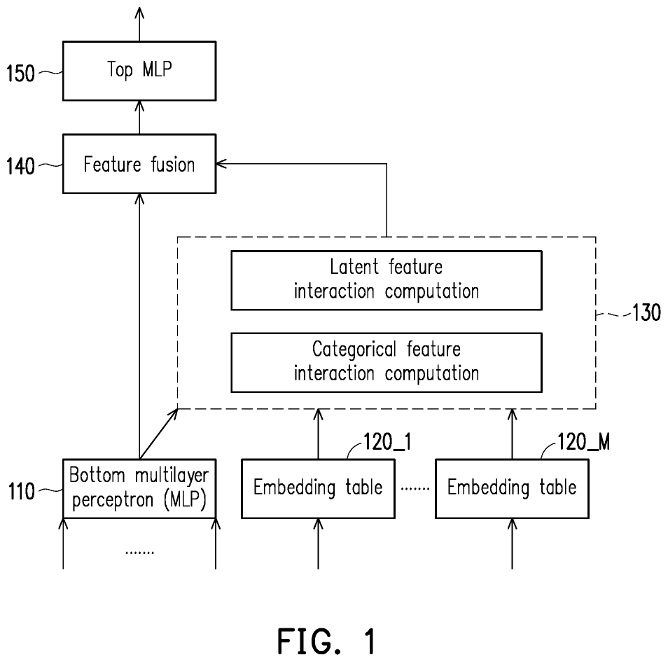

FIG. 1 is a schematic diagram of a neural network framework of a deep learning recommendation model (DLRM) according to an embodiment of the present invention. The DLRM may be applied as a recommendation system. The DLRM shown in FIG. 1 includes a bottom multilayer perceptron (bottom MLP) 110, embedding tables 120_1-120_M, a total interaction 130, a feature fusion 140, and a top MLP 150. The bottom MLP 110 is responsible for processing continuous features or numerical features, such as user ages, etc., and then provides a processing result (a categorical feature vectors) to the total interaction 130 and the feature fusion 140. The embedding tables 120_1-120_M may encode sparse and high-dimensional categorical features into dense embedding vectors, and then provide the embedding vectors (categorical feature vectors) to the total interaction 130.

The total interaction 130 may perform categorical feature interaction computation and latent feature interaction computation on a plurality of categorical feature vectors coming from the bottom MLP 110 and the embedding tables 120_1-120_M to generate a total interaction result for the feature fusion 140. The feature fusion 140 may fuse the categorical vectors coming from the bottom MLP 110 and the total interaction result (vector) from the total interaction 130 to produce fused feature vectors for the top MLP 150. The top MLP 150 may process the fused feature vectors. A processing result of the top MLP 150 may be used as a recommendation result of a deep learning recommendation model (recommendation system) shown in FIG. 1, such as a click-through rate of the user.

In a click-through rate prediction task of the recommender system, how to accurately capture a complex interaction relationship between various features is crucial. Computation of feature interactions is one of the keys that affects accuracy of a prediction model. A total interaction technique of the total interaction 130 may learn the feature interaction relationship more effectively. The total interaction technique may simultaneously learn an interaction relationship between categorical features and an interaction relationship between latent features in the categorical features, and then construct higher-order combined features to improve the ability of fitting complex feature interaction relationships, thereby improving accuracy of a recommendation model in the click-through rate prediction task. Specific implementations of the total interaction 130 shown in FIG. 1 will be described below in multiple embodiments.

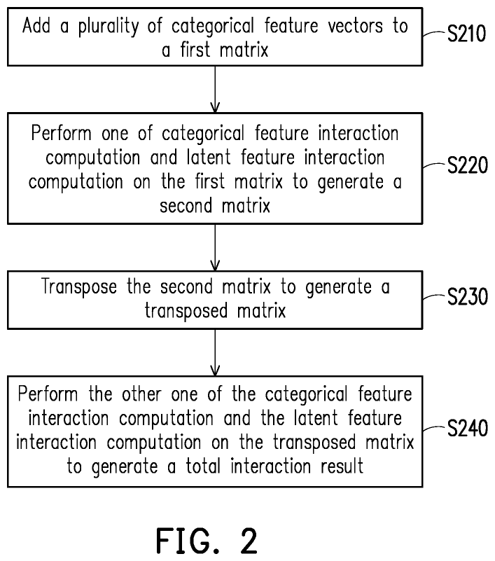

FIG. 2 is a schematic flowchart of a total interaction method according to an embodiment of the invention. The total interaction 130 shown in FIG. 1 may execute the total interaction method shown in FIG. 2 to generate the total interaction result for the feature fusion 140. According to different design requirements, an implementation manner of the total interaction 130 may be hardware, firmware, software (i.e., a program), or a combination thereof. In the form of software and/or firmware, related functions of the total interaction 130

may be implemented as programming codes. For example, the total interaction 130 is implemented by using general programming languages (for example, C, C++, or assembly language) or other suitable programming languages. The programming code may be recorded/stored in a “non-transitory computer readable medium”. In some embodiments, the non-transitory computer readable medium includes, for example, a semiconductor memory, a programmable logic circuit, and/or a storage device. A central processing unit (CPU), a controller, a microcontroller or a microprocessor may read and execute the programming code from the non-transitory computer readable medium, thereby realizing the related functions of the total interaction 130. Alternatively, the programming code may be provided to an electronic device (for example, a computer, a CPU, a controller, a microcontroller, or a microprocessor) via any transmission medium (for example, a communication network or broadcast waves, etc.). The communication network is, for example, the Internet, a wired communication network, a wireless communication network, or other communication media.

In terms of hardware, the total interaction 130 may be implemented as a logic circuit on an integrated circuit. The related functions of the total interaction 130 may be implemented in hardware by using hardware description languages (for example, Verilog HDL or VHDL) or other suitable programming languages. For example, the related functions of the full interaction 130 may be implemented in one or a plurality of controllers, microcontrollers, microprocessors, application-specific integrated circuits (ASICs), digital signal processors (DSP), field programmable gate array (FPGA) and/or various logic blocks, modules and circuits in other processing units.

In step S210, the total interaction 130 may add a plurality of categorical feature vectors to a first matrix. For example, it is assumed that the total interaction 130 receives four categorical feature vectors v1, v2, v3, and v4 from the bottom MLP 110 and the embedding tables 120_1-120_M. In some embodiments, these categorical feature vectors v1, v2, v3 and v4 are respectively used as different corresponding rows in the first matrix. In other embodiments, these categorical feature vectors v1, v2, v3 and v4 are respectively used as different corresponding columns in the first matrix.

Each of these categorical feature vectors v1, v2, v3 and v4 includes a plurality of latent features. For example, it is assumed that the categorical feature vector v1 includes elements e11, e12 and e13, the categorical feature vector v2 includes elements e21, e22 and e23, the categorical feature vector v3 includes elements e31, e32 and e33, and the categorical feature vector v4 includes elements e41, e42 and e43. The elements ell, e12 and e13 are the three latent features in the categorical feature vector v1. Description of the other categorical feature vectors v2, v3 and v4 may be deduced by referring to the relevant description of the categorical feature vector v1, and details thereof are not repeated.

In step S220, the total interaction 130 may perform one of categorical feature interaction computation and latent feature interaction computation on the first matrix to generate a second matrix. In step S230, the total interaction 130 may transpose the second matrix to generate a transposed matrix. In step S240, the total interaction 130 may perform the other one of the categorical feature interaction computation and the latent feature interaction computation on the transposed matrix to generate a total interaction result. In this way, the total interaction 130 may construct higher order combined features, improve the ability to fit complex relationships, and further improve the accuracy of the recommendation model in the click-through rate prediction task.

For example, in some embodiments, in step S220, the categorical feature interaction computation may be performed on the first matrix, and in step S240, the latent feature interaction computation may be performed on the transposed matrix. In detail, it is assumed that the categorical feature vectors v1, v2, v3 and v4 are respectively used as different corresponding columns in the first matrix, and in any iteration of the categorical feature interaction computation in step S220, the total interaction 130 may perform feature interaction computations on a plurality of elements in a corresponding row of the first matrix to generate a corresponding row of the second matrix. In any iteration of the latent feature interaction computation of step S240, the total interaction 130 may perform feature interaction computations on a plurality of elements in a corresponding row of the transposed matrix to generate a corresponding row of the total interaction result.

In other embodiments, in step S220, the latent feature interaction computation may be performed on the first matrix, and in step S240, the categorical feature interaction computation may be performed on the transposed matrix. For example, it is assumed that the categorical feature vectors v1, v2, v3 and v4 are respectively used as different corresponding columns in the first matrix, and in any iteration of the latent feature interaction computation in step S220, the total interaction 130 may perform feature interaction computations on a plurality of elements in a corresponding column of the first matrix to generate a corresponding column of the second matrix. In any iteration of the categorical feature interaction computation of step S240, the total interaction 130 may perform feature interaction computations on a plurality of elements in a corresponding column of the transposed matrix to generate a corresponding column of the total interaction result.

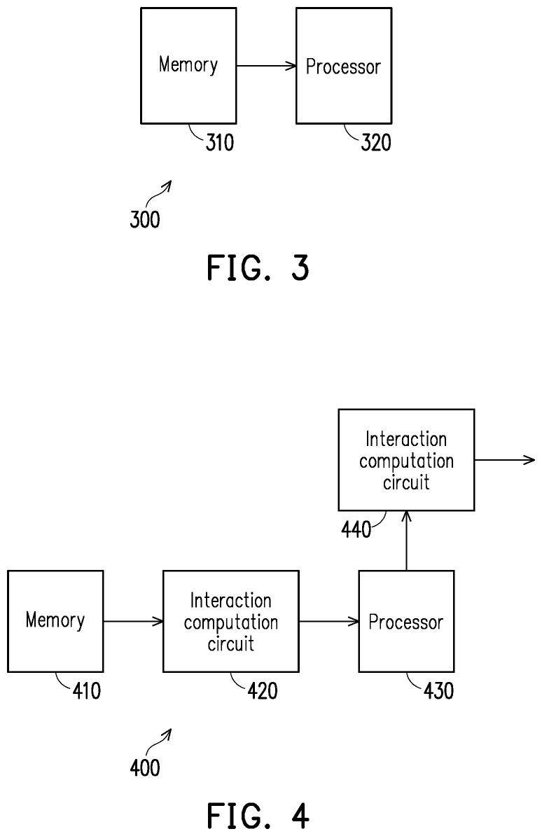

FIG. 3 is a schematic circuit block diagram of a total interaction device 300 according to an embodiment of the invention. The total interaction device 300 shown in FIG. 3 may compute an interaction relationship between a plurality of features in the recommendation system. The total interaction 130 shown in FIG. 1 may refer to the relevant description of the total interaction device 300 shown in FIG. 3, and/or the total interaction device 300 shown in FIG. 3 may refer to the relevant description of the total interaction 130 shown in FIG. 1. The total interaction device 300 shown in FIG. 3 may execute the total interaction method shown in FIG. 2 to generate the total interaction result.

In the embodiment shown in FIG. 3, the total interaction device 300 includes a memory 310 and a processor 320. The memory 310 may provide a first matrix to the processor 320. As that described above, a plurality of categorical feature vectors may be added to the first matrix, and each of the categorical feature vectors includes a plurality of latent features. The processor 320 is coupled to the memory 310. In step S220, the processor 320 may perform one of categorical feature interaction computation and the latent feature interaction computation on the first matrix to generate a second matrix. In step S230, the processor 320 may transpose the second matrix to generate a transposed matrix. In step S240, the processor 320 may perform the other one of the categorical feature interaction computation and the latent feature interaction computation on the transposed matrix to generate a total interaction result.

FIG. 4 is a schematic circuit block diagram of a total interaction device 400 according

to another embodiment of the invention. The total interaction device 400 shown in FIG. 4 may compute an interaction relationship between a plurality of features in the recommendation system. The total interaction 130 shown in FIG. 1 may refer to the relevant description of the total interaction device 400 shown in FIG. 4, and/or the total interaction device 400 shown in FIG. 4 may refer to the relevant description of the total interaction 130 shown in FIG. 1. The total interaction device 400 shown in FIG. 4 may execute the total interaction method shown in FIG. 2 to generate a total interaction result.

In the embodiment shown in FIG. 4, the total interaction device 400 includes a memory 410, an interaction computation circuit 420, a memory 430 and an interaction computation circuit 440. The memory 410 may store a plurality of categorical feature vectors. As that described above, the plurality of categorical feature vectors may be added to the first matrix, and each of the categorical feature vectors includes a plurality of latent features. The interaction computation circuit 420 is coupled to the memory 410 for accessing the first matrix. In step S220, the interaction computation circuit 420 may perform one of categorical feature interaction computation and the latent feature interaction computation on the first matrix to generate a second matrix. In step S230, the memory 430 may transpose the second matrix to generate a transposed matrix. The interaction computation circuit 440 is coupled to memory 430 to receive the transposed matrix. In step S240, the interaction computation circuit 440 may perform the other one of the categorical feature interaction computation and the latent feature interaction computation on the transposed matrix to generate a total interaction result.

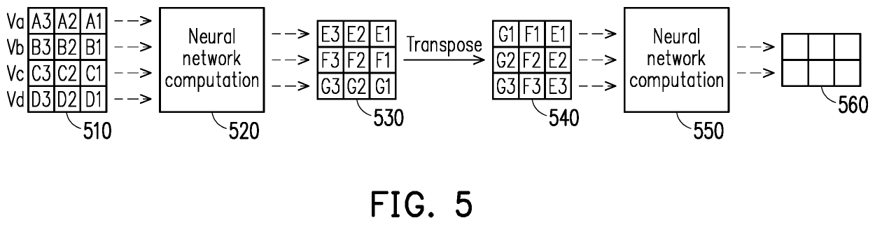

FIG. 5 is a schematic diagram of a process of performing total interaction computation on the first matrix according to an embodiment of the invention. The related descriptions of the total interaction computation shown in FIG. 5 may be applied to the total interaction 130 shown in FIG. 1, the total interaction device 300 shown in FIG. 3, and the total interaction device 400 shown in FIG. 4. k categorical feature vectors are respectively used as different corresponding rows in a first matrix 510, where k is an integer. In the embodiment shown in FIG. 5, it is assumed that a plurality of categorical feature vectors Va, Vb, Vc and Vd are respectively used as different corresponding rows in the first matrix 510. Each of these categorical feature vectors Va, Vb, Vc, and Vd includes d latent features, where d is an integer. For example, the categorical feature vector Va includes latent features (elements) A1, A2 and A3, the categorical feature vector Vb includes latent features (elements) B1, B2 and B3, the categorical feature vector Vc includes latent features (elements) C1, C2 and C3, and the categorical feature vector Vd includes latent features (elements) D1, D2 and D3.

In step S220, the categorical feature interaction computation may be performed on the first matrix 510 to generate a second matrix 530. In the embodiment shown in FIG. 5, the categorical feature interaction computation includes a plurality of iterations. In a first iteration, in step S220, neural network computations 520 may be performed on the first latent features A1, B1, C1, and D1 of each of the categorical feature vectors Va, Vb, Vc, and Vd to generate first column elements E1, F1 and G1 of the second matrix 530. It should be noted that dimensions of the first matrix 510 and the second matrix 530 are only simple examples. The actual dimensions of the first matrix 510 and the second matrix 530 may be determined according to an actual design and/or application requirements.

According to actual design, in some embodiments, the neural network computation 520 includes multilayer perceptron (MLP) computation. A multilayer perceptron is a type of neural network. The multilayer perceptron may map a set of input vectors to a set of output vectors. The multilayer perceptron consists of a plurality of node layers, and each node layer is fully connected to a next node layer. Except for an input node, each node of the multilayer perceptron is a neuron with a nonlinear activation function. The multilayer perceptron has a powerful capability in feature representation learning. The multilayer perceptron may be applied in the categorical feature interaction computation to aggregate cross category information. In other embodiments, the neural network computation 520 includes convolutional neural network (CNN) computation or other neural network computations.

In a second iteration of the categorical feature interaction computation, in step S220, the neural network computation 520 may be performed on the second latent features A2, B2, C2 and D2 of the categorical feature vectors Va, Vb, Vc and Vd to generate second column elements E2 , F2 and G2 of the second matrix 530. In a third iteration of the categorical feature interaction computation, in step S220, the neural network computation 520 may be performed on the third latent features A3, B3, C3 and D3 of the categorical feature vectors Va, Vb, Vc and Vd to generate third row elements E3, F3 and G3 of the second matrix 530.

In step S230, the second matrix 530 may be transposed to generate a transposed matrix 540. A number of columns of the transposed matrix 540 is hc, which is an integer. In step S240, a latent feature interaction computation may be performed on the transposed matrix 540 to generate a total interaction result 560. In the embodiment shown in FIG. 5, the latent feature interaction computation includes a plurality of iterations. In a first iteration, in step S240, neural network computations 550 may be performed on the first column elements E1, E2 and E3 in the transposed matrix 540 to generate first column elements of the total interaction result 560. It should be noted that dimensions of the transposed matrix 540 and the total interaction result 560 are just simple examples. The actual dimensions of the transposed matrix 540 and the total interaction result 560 may be determined according to an actual design and/or application requirements.

According to an actual design, in some embodiments, the neural network computation 550 includes multilayer perceptron (MLP) computation. The multilayer perceptron may be applied in latent feature interaction computation to aggregate latent features in the categorical features. In other embodiments, the neural network computation 550 includes convolutional neural network (CNN) computation or other neural network computations.

In a second iteration of the latent feature interaction computation, in step S240, the neural network computation 550 may be performed on the second column elements F1, F2 and F3 in the transposed matrix 540 to generate second column elements of the total interaction result 560. In a third iteration of the latent feature interaction computation, in step S240, the neural network computation 550 may be performed on the third column elements G1, G2 and G3 in the transposed matrix 540 to generate third column elements of the total interaction result 560.

In conclusion, the categorical feature vectors Va, Vb, Vc and Vd described in the above embodiments are added to the first matrix 510. The first matrix 510 is subjected to the neural network computation 520 (a first feature interaction computation) to produce the second matrix 530. The second matrix 530 is transposed to produce the transposed matrix 540. The transposed matrix 540 is subjected to the neural network computation 550 (second feature interaction computation) to produce the total interaction result 560. Therefore, the total interaction result 560 includes the categorical feature interaction relationships as well as the latent feature interaction relationship.

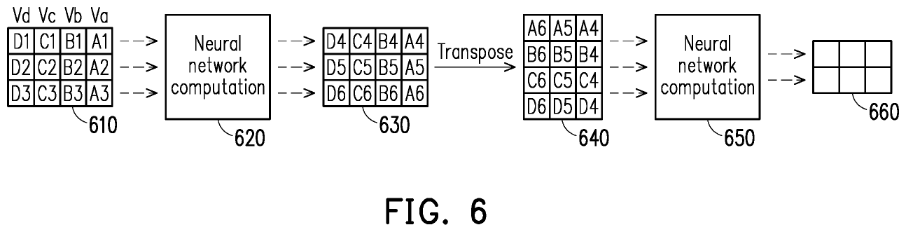

FIG. 6 is a schematic diagram of a process of performing total interaction computation on the first matrix according to another embodiment of the invention. Related descriptions of the total interaction computation shown in FIG. 6 may be applied to the total interaction 130 shown in FIG. 1, the total interaction device 300 shown in FIG. 3, and the total interaction device 400 shown in FIG. 4. In the embodiment shown in FIG. 6, it is assumed that a plurality of categorical feature vectors Va, Vb, Vc and Vd are respectively used as different corresponding columns in a first matrix 610. For the categorical feature vectors Va, Vb, Vc and Vd shown in FIG. 6, reference may be made to the related descriptions of the categorical feature vectors Va, Vb, Vc and Vd shown in FIG. 5, so that details thereof are not repeated.

In step S220, the latent feature interaction computation may be performed on the first matrix 610 to generate a second matrix 630. In the embodiment shown in FIG. 6, the latent feature interaction computation includes a plurality of iterations. In a first iteration, in step S220, neural network computations 620 may be on all of the latent features (elements) A1, A2 and A3 of the first categorical feature vector Va in the categorical feature vectors Va, Vb, Vc and Vd, to generate first column elements A4, A5 and A6 of the second matrix 630. It should be noted that dimensions of the first matrix 610 and the second matrix 630 are only simple examples. The actual dimensions of the first matrix 610 and the second matrix 630 may be determined according to an actual design and/or application requirements.

According to an actual design, in some embodiments, the neural network computation 620 includes multilayer perceptron (MLP) computation. The multilayer perceptron may be applied in latent feature interaction computation to aggregate latent features in a same categorical feature. In other embodiments, the neural network computation 620 includes convolutional neural network (CNN) computation or other neural network computations.

In a second iteration of the latent feature interaction computation, in step S220, the neural network computation 620 may be performed on all latent features (elements) B1, B2 and B3 of a second categorical feature vector Vb in the categorical feature vectors Va, Vb, Vc and Vd to generate second column elements B4, B5 and B6 of the second matrix 630. In a third iteration of the latent feature interaction computation, in step S220, the neural network computation 620 may be performed on all latent features (elements) C1, C2 and C3 of a third categorical feature vector Vc in the categorical feature vectors Va, Vb, Vc and Vd to generate third column elements C4, C5 and C6 of the second matrix 630. In a fourth iteration of the latent feature interaction computation, in step S220, the neural network computation 620 may be performed on all latent features (elements) D1, D2 and D3 of a fourth categorical feature vector Vd in the categorical feature vectors Va, Vb, Vc and Vd to generate fourth column elements D4, D5 and D6 of the second matrix 630.

In step S230, the second matrix 630 may be transposed to generate a transposed matrix 640. A number of columns of the transposed matrix 640 is hc, which is an integer. In step S240, categorical feature interaction computation may be performed on the transposed matrix 640 to generate a total interaction result 660. In the embodiment shown in FIG. 6, the categorical feature interaction computation includes a plurality of iterations. In a first iteration, in step S240, a neural network computation 650 may be performed on first column elements A4, B4, C4, and D4 in the transposed matrix 640 to produce first column elements of a total interaction result 660. It should be noted that dimensions of the transposed matrix 640 and the total interaction result 660 are just simple examples. The actual dimensions of the transposed matrix 640 and the total interaction result 660 may be determined according to an actual design and/or application requirements.

According to an actual design, in some embodiments, the neural network computation 650 includes multilayer perceptron (MLP) computation. The multilayer perceptron may be applied in categorical feature interaction computation to aggregate cross category information. In some other embodiments, the neural network computation 650 includes convolutional neural network (CNN) computation or other neural network computations.

In a second iteration of the categorical feature interaction computation, in step S240, the neural network computation 650 may be performed on second column elements A5, B5, C5, and D5 in the transposed matrix 640 to produce second column elements of the total interaction result 660. In a third iteration of the categorical feature interaction computation, in step S240 the neural network computation 650 may be performed on third column elements A6, B6, C6 and D6 in the transposed matrix 640 to generate third column elements of the total interaction result 660.

In summary, the categorical feature vectors Va, Vb, Vc and Vd described in the above embodiments are added to the first matrix 610. The first matrix 610 is subjected to the neural network computation 620 (a first feature interaction computation) to produce the second matrix 630. The second matrix 630 is transposed to produce the transposed matrix 640. The transposed matrix 640 is subjected to the neural network computation 650 (a second feature interaction computation) to produce the total interaction result 660. Therefore, the total interaction result 660 includes the categorical feature interaction relationships as well as the latent feature interaction relationship.

In a conventional feature interaction method, all second-order interactions are usually

simply enumerated, and the categorical feature interaction relationship is computed in a simple way, such as an inner product of pairwise categorical features. On the other hand, many prior techniques also ignore the relationships between latent features learned during the embedding learning process, and only compute and learn the interaction relationships for different categorical features. Different from the prior techniques, the above-mentioned embodiments utilize the powerful capability of multilayer perceptron (MLP) in feature representation learning in a machine learning manner to realize automatic feature interaction. The above-mentioned embodiments may effectively perform feature interaction between categorical features and between latent features in the categorical features, so that it is referred to as a total interaction technology. The total interaction technology only needs computational cost of standard matrix multiplication, and captures various feature interactions in a better way, thereby improving a performance of a recommendation model in the click-through rate prediction task.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. A total interaction method, configured to compute an interaction relationship between a plurality of features in a recommendation system, comprising:
adding a plurality of categorical feature vectors to a first matrix, wherein each of the categorical feature vectors comprises a plurality of latent features;
performing one of categorical feature interaction computation and latent feature interaction computation on the first matrix to generate a second matrix;
transposing the second matrix to generate a transposed matrix; and
performing the other one of the categorical feature interaction computation and the latent feature interaction computation on the transposed matrix to generate a total interaction result.

2. The total interaction method as claimed in claim 1, wherein the categorical feature interaction computation comprises a plurality of iterations, and an i^{th} iteration of the iterations comprises:
performing neural network computation on an i^{th} latent feature of each of the categorical feature vectors to generate an i^{th} column element of the second matrix, wherein each of the categorical feature vectors comprises d latent features, d is an integer, and i is an integer greater than 0 and less than or equal to d.

3. The total interaction method as claimed in claim 2, wherein the neural network computation comprises multilayer perceptron computation or convolutional neural network computation.

4. The total interaction method as claimed in claim 1, wherein the latent feature interaction computation comprises a plurality of iterations, and an i^{th} iteration of the iterations comprises:
performing neural network computation on an i^{th} column element of the transposed matrix to generate an i^{th} column element of the total interaction result, wherein a number of columns of the transposed matrix is hc, hc is an integer, and i is an integer greater than 0 and less than or equal to hc.

5. The total interaction method as claimed in claim 4, wherein the neural network computation comprises multilayer perceptron computation or convolutional neural network computation.

6. The total interaction method as claimed in claim 1, wherein the latent feature interaction computation comprises a plurality of iterations, and an i^{th} iteration of the iterations comprises:
performing neural network computation on all latent features of an i^{th} categorical feature vector in the categorical feature vectors to generate an i^{th} column element of the second matrix, wherein a number of the categorical feature vectors is k, k is an integer, and i is an integer greater than 0 and less than or equal to k.

7. The total interaction method as claimed in claim 1, wherein the categorical feature interaction computation comprises a plurality of iterations, and an i^{th} iteration of the iterations comprises:
performing categorical of neural network computation on an i^{th} column element of the transposed matrix to generate an i^{th} column element of the total interaction result, wherein a number of columns of the transposed matrix is hc, hc is an integer, and i is an integer greater than and less than or equal to hc.

8. A total interaction device, configured to compute an interaction relationship between a plurality of features in a recommendation system, comprising:
a first memory, configured to store a plurality of categorical feature vectors, wherein the categorical feature vectors are added to a first matrix, and each of the categorical feature vectors comprises a plurality of latent features;
a first interaction computation circuit, coupled to the first memory, and configured to perform one of categorical feature interaction computation and latent feature interaction computation on the first matrix to generate a second matrix;
a second memory, coupled to the first interaction computation circuit to receive the second matrix, and configured to transpose the second matrix to generate a transposed matrix; and
a second interaction computation circuit, coupled to the second memory to receive the transposed matrix, and configured to perform the other one of the categorical feature interaction computation and the latent feature interaction computation on the transposed matrix to generate a total interaction result.

9. The total interaction device as claimed in claim 8, wherein the categorical feature interaction computation performed by the first interaction computation circuit comprises a plurality of iterations, and an i^{th} iteration of the iterations comprises:
performing neural network computation on an i^{th} latent feature of each of the categorical feature vectors to generate an i^{th} column element of the second matrix, wherein each of the categorical feature vectors comprises d latent features, d is an integer, and i is an integer greater than 0 and less than or equal to d.

10. The total interaction device as claimed in claim 9, wherein the neural network computation comprises multilayer perceptron computation or convolutional neural network computation.

11. The total interaction device as claimed in claim 8, wherein the latent feature interaction computation performed by the second interaction computation circuit comprises a plurality of iterations, and an i^{th} iteration of the iterations comprises:
performing neural network computation on an i^{th} column element of the transposed matrix to generate an i^{th} column element of the total interaction result, wherein a number of columns of the transposed matrix is hc, he is an integer, and i is an integer greater than 0 and less than or equal to hc.

12. The total interaction device as claimed in claim 11, wherein the neural network computation comprises multilayer perceptron computation or convolutional neural network computation.

13. The total interaction device as claimed in claim 8, wherein the latent feature interaction computation performed by the first interaction computation circuit comprises a plurality of iterations, and an i^{th} iteration of the iterations comprises:
performing neural network computation on all latent features of an i^{th} categorical feature vector in the categorical feature vectors to generate an i^{th} column element of the second matrix, wherein a number of the categorical feature vectors is k, k is an integer, and i is an integer greater than 0 and less than or equal to k.

14. The total interaction device as claimed in claim 8, wherein the categorical feature interaction computation performed by the second interaction computation circuit comprises a plurality of iterations, and an i^{th} iteration of the iterations comprises:
performing categorical neural network computation on an i^{th} column element of the transposed matrix to generate an i^{th} column element of the total interaction result, wherein a number of columns of the transposed matrix is hc, hc is an integer, and i is an integer greater than and less than or equal to hc.

15. A total interaction device, configured to compute an interaction relationship between a plurality of features in a recommendation system, comprising:
a memory, configured to provide a first matrix, wherein a plurality of categorical feature vectors are added to the first matrix, and each of the categorical feature vectors comprises a plurality of latent features; and
a processor, coupled to the memory, wherein the processor performs one of categorical feature interaction computation and latent feature interaction computation on the first matrix to generate a second matrix, the processor transposes the second matrix to generate a transposed matrix, and the processor performs the other one of the categorical feature interaction computation and the latent feature interaction computation on the transposed matrix to generate a total interaction result.

16. The total interaction device as claimed in claim 15, wherein the categorical feature interaction computation performed by the processor comprises a plurality of iterations, and an i^{th} iteration of the iterations comprises:
performing neural network computation on an i^{th} latent feature of each of the categorical feature vectors to generate an i^{th} column element of the second matrix, wherein each of the categorical feature vectors comprises d latent features, d is an integer, and i is an integer greater than 0 and less than or equal to d.

17. The total interaction device as claimed in claim 16, wherein the neural network computation comprises multilayer perceptron computation or convolutional neural network computation.

18. The total interaction device as claimed in claim 15, wherein the latent feature interaction computation performed by the processor comprises a plurality of iterations, and an i^{th} iteration of the iterations comprises:
performing neural network computation on an i^{th} column element of the transposed matrix to generate an i^{th} column element of the total interaction result, wherein a number of columns of the transposed matrix is hc, hc is an integer, and i is an integer greater than 0 and less than or equal to hc.

19. The total interaction device as claimed in claim 18, wherein the neural network computation comprises multilayer perceptron computation or convolutional neural network computation.

20. The total interaction device as claimed in claim 15, wherein the latent feature interaction computation performed by the processor comprises a plurality of iterations, and an i^{th} iteration of the iterations comprises:
performing neural network computation on all latent features of an i^{th} categorical feature vector in the categorical feature vectors to generate an i^{th} column element of the second matrix, wherein a number of the categorical feature vectors is k, k is an integer, and i is an integer greater than 0 and less than or equal to k.

21. The total interaction device as claimed in claim 15, wherein the categorical feature interaction computation performed by the processor comprises a plurality of iterations, and an i^{th} iteration of the iterations comprises:
performing categorical neural network computation on an i^{th} column element of the transposed matrix to generate an i^{th} column element of the total interaction result, wherein a number of columns of the transposed matrix is hc, hc is an integer, and i is an integer greater than 0 and less than or equal to hc.
